(19) United States
(12) Patent Application Publication
(10) Pub. No.: US 2014/0175870 A1
(43) Pub. Date: Jun. 26, 2014

(54) ELECTRIC CURRENT DETECTION APPARATUS OF LOW VOLTAGE DC-DC CONVERTER FOR ELECTRIC VEHICLE

(71) Applicant: HYUNDAI MOBIS CO., LTD., Seoul (KR)

(72) Inventor: Bum Yul KIM, Seongnam-si (KR)

(73) Assignee: HYUNDAI MOBIS CO., LTD., Seoul (KR)

(21) Appl. No.: 13/847,180

(22) Filed: Mar. 19, 2013

(30) Foreign Application Priority Data
Dec. 26, 2012 (KR) 10-2012-0152935

(51) Int. Cl. H02M 3/335

(52) U.S. Cl. CPC H02M 3/33515
USPC 307/10.1

(57) ABSTRACT

Disclosed is an electric current detection apparatus of a low voltage DC-DC converter for an electric vehicle, including: a low voltage DC-DC converter (LDC) which converts a voltage of an electric power source applied from a high voltage battery into a low voltage; a current transformer (CT) which is provided at a front terminal of a main voltage transformer to convert an electric current value of an input terminal of the main voltage transformer; and a calculation unit which calculates an electric current value of an output terminal of the main voltage transformer by receiving an output side electric current of the current transformer. The electric current detection apparatus may detect an output electric current of the low voltage DC-DC converter without using a high priced electric current sensor.

### CROSS-REFERENCE TO RELATED APPLICATIONS

This application claims priority to and the benefit of Korean Patent Application No. 10-2012-0152935 filed in the Korean Intellectual Property Office on Dec. 26, 2012, the entire contents of which are incorporated herein by reference.

### TECHNICAL FIELD

The present invention relates to an electric current detection apparatus of a low voltage DC-DC converter for an electric vehicle, and more particularly, to an electric current detection apparatus of a low voltage DC-DC converter for an electric vehicle, capable of detecting an electric current of an output terminal of the low voltage DC-DC converter without using an electric current sensor.

### BACKGROUND ART

In general, as an electrical apparatus of a vehicle, an engine electrical apparatus (a starting apparatus, an ignition apparatus, or a charge apparatus) and a lighting apparatus are generally used. In recent years, as the vehicles are being more electronically controllable, most of the systems including a chassis electrical apparatus are being electrically and electronically controllable.

Various types of electronic equipment installed in the vehicle, such as a lamp, an audio system, a heater, an air conditioner, or the like, are supplied with electric power from a battery when the vehicle is stopped, and are supplied with electric power from a power generator while the vehicle is driven. Here, a generation capacity of a 14 V power source system is used as a typical power supply voltage.

In recent years, various new technologies aimed at developing an information technology industry and improving convenience of the vehicle are adapted to the vehicle, and there is an expectation that development on the new technology that makes the present vehicle system maximally usable in the future will be continued.

As well known, a low voltage DC-DC converter (LDC) is installed in an electric vehicle such as a hybrid electric vehicle (HEV), a fuel cell vehicle, a fuel cell hybrid vehicle, or the like, to charge a 12 V battery (an auxiliary battery) and supply electric power to a 12 V electric field load.

The low voltage DC-DC converter that serves as a power generator of a general gasoline vehicle drops a high voltage of a main battery (a typical high voltage battery having a voltage equal to or greater than 144 V) to supply a voltage of 12 V, and converts a high voltage (DC) of regenerative energy produced by the main battery or a driving motor into a voltage of 12 V (DC) to charge an auxiliary battery (a 12 V battery) or supply electric power to an electric field load.

According to the low voltage DC-DC converter in the related art, an electric current sensor is installed at an output terminal of the low voltage DC-DC converter to measure an electric current value for the purpose of monitoring the electric current and controlling the electric current. The electric current value measured by the electric current sensor is inputted to a microcomputer through a sensing circuit, an electric current signal inputted to the microcomputer is read as a voltage through the sensing circuit, and the voltage is converted to an actual electric current value after a software process is performed.

Because a high priced electric current sensor is used in the related art, there is a problem in that manufacturing costs are increased.

### SUMMARY OF THE INVENTION

The present invention has been made in an effort to provide an electric current detection apparatus of a low voltage DC-DC converter for an electric vehicle, capable of calculating an output electric current of the low voltage DC-DC converter without using a high priced electric current sensor.

An exemplary embodiment of the present invention provides an electric current detection apparatus of a low voltage DC-DC converter for an electric vehicle, including: a low voltage DC-DC converter (LDC) configured to convert a voltage of an electric power source applied from a high voltage battery into a low voltage; a current transformer (CT) provided at a front terminal of a main voltage transformer of the low voltage DC-DC converter and configured to convert an electric current value of an input terminal of the main voltage transformer; and a calculation unit configured to calculate an electric current value of an output terminal of the main voltage transformer by receiving an output side electric current of the current transformer.

The calculation unit may include a sensing circuit configured to receive the output side electric current of the current transformer and output a voltage value, and a microcomputer configured to receive the voltage value from the sensing circuit and calculate the electric current value of the output terminal of the main voltage transformer.

The calculation unit may further include a smoothing circuit configured to change a voltage signal inputted from the sensing circuit to a direct current form which is convertible to a digital value by software.

The microcomputer may block an output of an electric power source of the main voltage transformer, when an excessive electric current flows in the input terminal of the main voltage transformer.

Another exemplary embodiment of the present invention provides an electric current detection method of a low voltage DC-DC converter for an electric vehicle, including: dropping an input side electric current of a main voltage transformer of the low voltage DC-DC converter by a current transformer; converting an output side electric current of the current transformer into a sensing voltage value by inputting the output side electric current of the current transformer to a sensing circuit including sensing resistance; and calculating an output side electric current value of the main voltage transformer by using the sensing voltage value.

The electric current detection method of the low voltage DC-DC converter for an electric vehicle may further include removing a ripple by inputting the sensing voltage value to a smoothing circuit after the converting of the output side electric current of the current transformer into the sensing voltage value.

The electric current detection apparatus of the low voltage DC-DC converter for an electric vehicle, according to the exemplary embodiment of the present invention, may detect an output electric current of the low voltage DC-DC converter without using a high priced electric current sensor.

In a case in which an excessive electric current flows in the input terminal of the low voltage DC-DC converter, an output of the low voltage DC-DC converter is blocked, and thereby damage to the system may be prevented.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a circuit diagram of an electric current detection apparatus of a low voltage DC-DC converter for an electric vehicle, according to an exemplary embodiment of the present invention.

FIG. 2 is a flow chart of an electric current detection method of the low voltage DC-DC converter for an electric vehicle, according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. It should be understood that although exemplary embodiments of the present invention are described hereafter, the spirit of the present invention is not limited thereto and the present invention may be changed and modified in various ways by those skilled in the art.

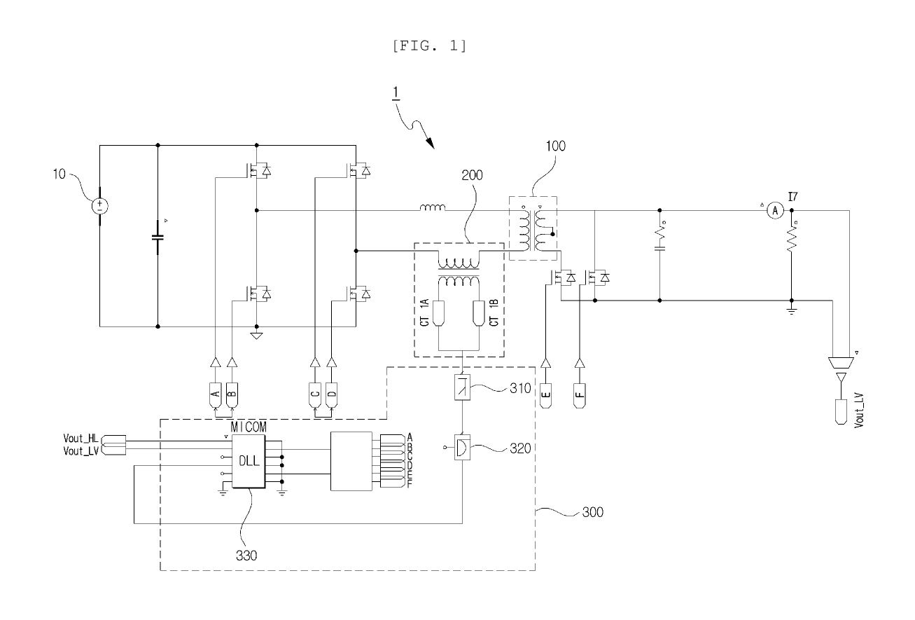

FIG. 1 is a circuit diagram of an electric current detection apparatus of a low voltage DC-DC converter for an electric vehicle, according to an exemplary embodiment of the present invention.

FIG. 1 clearly illustrates only main characteristic portions for conceptually and clearly understanding the present invention. As a result, various modifications of the illustration are expected, and the scope of the present invention is not limited to specific shapes illustrated in the drawing.

Referring to FIG. 1, an electric current detection apparatus 1 of a low voltage DC-DC converter for an electric vehicle, according to an exemplary embodiment of the present invention, includes a low voltage DC-DC converter (LDC) which converts a voltage of an electric power source applied from a high voltage battery 10 into a low voltage, a current transformer (CT) 200 which is provided at a front terminal of a main voltage transformer 100 of the low voltage DC-DC converter to convert an electric current value of an input terminal of the main voltage transformer 100, and a calculation unit 300 which calculates an electric current value of an output terminal of the main voltage transformer 100 by receiving an output side electric current of the current transformer 200.

The low voltage DC-DC converter drops a high voltage of the high voltage battery 10 to a low voltage and supplies the low voltage to an electric field load. The voltage drop is performed by the main voltage transformer 100.

The current transformer 200 is connected to the input terminal of the main voltage transformer 100 of the low voltage DC-DC converter to drop an electric current value of the input terminal of the main voltage transformer 100. In the exemplary embodiment, the current transformer 200 has a turn ratio of 100:1, and an electric current of 1 A is converted into an electric current of 0.01 A by the current transformer 200.

The calculation unit 300 includes a sensing circuit 310 which receives the output side electric current of the current transformer 200 and outputs a voltage value, a smoothing circuit 320 which changes a voltage signal inputted from the sensing circuit 310 to a direct current form which is convertible to a digital value by software, and a microcomputer 330 which receives the voltage value from the sensing circuit 310 and calculates the electric current value of the output terminal of the main voltage transformer 100.

The sensing circuit 310 receives an electric current dropped by the current transformer 200 and outputs a voltage value. The sensing circuit 310 includes sensing resistance and thus converts an electric current value inputted to the sensing circuit 310 into a voltage value, which is applied to the sensing resistance, and outputs the voltage value.

The smoothing circuit 320 removes an alternating current component included in a direct current after being rectified, and converts the voltage value outputted from the sensing circuit 310 into a pure direct current value which is convertible to a digital value by software. In other words, the smoothing circuit 320 removes a ripple component included in an inputted value and outputs a rectified value.

The microcomputer 330 calculates an output side electric current value of the main voltage transformer 100 by software logic by using the voltage value inputted from the smoothing circuit 320.

The calculation process performed by the microcomputer 330 will be described below.

First, an output electric current value of the current transformer 200 is calculated by using the voltage value outputted from the sensing circuit 310.

I (output electric current of current transformer 200)=V (sensing voltage)/R (sensing resistance)

Next, an input electric current value of the current transformer 200 is calculated by using the output electric current value of the current transformer 200.

I (input electric current of current transformer 200))=I (output electric current of current transformer 200)×turn ratio of current transformer 200

Because the input electric current value of the current transformer 200 is the input electric current value of the main voltage transformer 100, the output side electric current value of the main voltage transformer 100 may be calculated from the input electric current value of the current transformer 200 in consideration with the turn ratio of the main voltage transformer 100.

I (output electric current of main voltage transformer 100)=I (input electric current of current transformer 200)×N1 (number of input turns)/N2 (number of output turns)

Here, N1 and N2 refer to the numbers of turns of an input side and an output side of the main voltage transformer 100, respectively.

Meanwhile, when it is determined that an input side electric current value of the main voltage transformer 100, which is calculated in the aforementioned process, is equal to or greater than a predetermined value, the microcomputer 330 blocks an output of an electric power source of the main voltage transformer 100.

As such, a system may be prevented from being damaged by an excessive electric current due to an abnormal operation.

An operation of the electric current detection apparatus 1 of the low voltage DC-DC converter for an electric vehicle, which has the aforementioned configuration, will be described below.

When an electric power source is connected to the main voltage transformer 100 of the low voltage DC-DC converter, an electric current which flows in the input terminal of the main voltage transformer 100 is inputted to an input terminal of the current transformer 200 which is connected to the input terminal of the main voltage transformer 100, and the electric current value dropped by the current transformer 200 is outputted to an output terminal of the current transformer 200.

The electric current of the output terminal of the current transformer 200 is converted into the sensing voltage value through the sensing circuit 310, and the sensing voltage value is rectified to be a digital process signal by the smoothing circuit 320.

The rectified sensing voltage value is calculated by calculation logic of the microcomputer 330 to sequentially be the output side electric current value of the current transformer 200, an input side electric current value of the current transformer 200, and an output side voltage value of the main voltage transformer 100.

Accordingly, the output side voltage value of the main voltage transformer 100, that is, an output side voltage value of the low voltage DC-DC converter may be calculated.

In a case in which it is determined that the input side electric current value of the current transformer 200, which is calculated by the microcomputer 330, is equal to or greater than a predetermined value, that is, in a case in which it is determined that the input side electric current value of the current transformer 200 is an excessive electric current, the microcomputer 330 blocks an output of the low voltage DC-DC converter through a control unit of the low voltage DC-DC converter.

As such, the electric current detection apparatus 1 of the low voltage DC-DC converter for an electric vehicle, according to the exemplary embodiment of the present invention, may detect the output electric current of the low voltage DC-DC converter without using a high priced electric current sensor. In a case in which an excessive electric current flows in the input terminal of the low voltage DC-DC converter, the output of the low voltage DC-DC converter is blocked, and thereby damage to the system may be prevented.

Meanwhile, hereinafter, an electric current detection method of the low voltage DC-DC converter for an electric vehicle, according to an exemplary embodiment of the present invention will be described below with reference to the accompanying drawing. However, a description regarding the same elements that are described with respect to the electric current detection apparatus 1 of the low voltage DC-DC converter for an electric vehicle, according to the exemplary embodiment of the present invention, will be omitted.

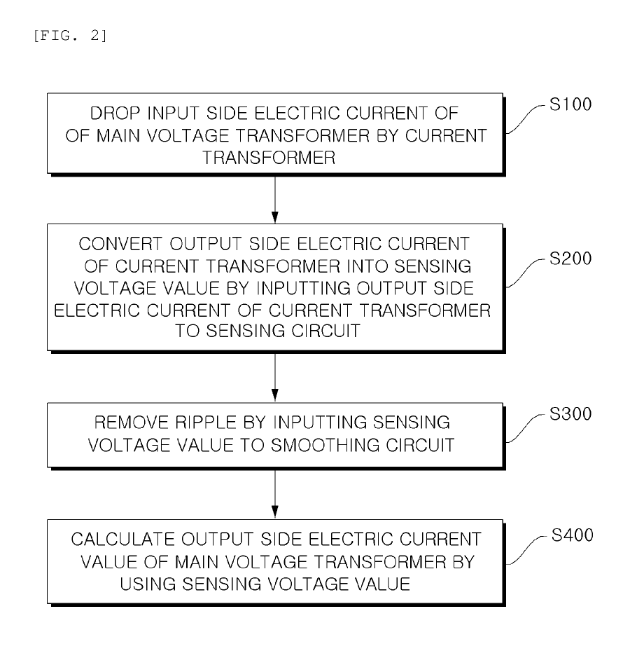

FIG. 2 is a flow chart of an electric current detection method of the low voltage DC-DC converter for an electric vehicle, according to the exemplary embodiment of the present invention.

Referring to FIG. 2, an electric current detection method of the low voltage DC-DC converter for an electric vehicle, according to the exemplary embodiment of the present invention, includes dropping the input side electric current of the main voltage transformer 100 of the low voltage DC-DC converter by the current transformer 200 (S100), converting the output side electric current of the current transformer 200 into the sensing voltage value by inputting the output side electric current of the current transformer 200 to the sensing circuit 310 including the sensing resistance (S200), removing a ripple by inputting the sensing voltage value to the smoothing circuit 320 (S300), and calculating the output side electric current value of the main voltage transformer 100 by using the sensing voltage value (S400).

In the dropping of the input side electric current of the main voltage transformer 100 by the current transformer 200 (S100), the input side electric current of the main voltage transformer 100 is inputted by connecting the current transformer 200 to the input terminal of the main voltage transformer 100 of the low voltage DC-DC converter. The input side electric current value of the main voltage transformer 100 is dropped by the current transformer 200. There is an effect in that the electric current value is easily detected by dropping the electric current value, and a loss of the electric power may be reduced.

In the converting of the output side electric current of the current transformer 200 into the sensing voltage value (S200), the output side electric current value of the current transformer 200 is converted into the voltage value, which is applied to the sensing resistance, through the sensing circuit 310 including the sensing resistance.

the removing of the ripple by inputting the sensing voltage value to the smoothing circuit 320 (S300), a noise alternating current component included in the sensing voltage value is removed to facilitate convention to a digital signal by the software logic in the microcomputer 330.

In the calculating of the output side electric current value of the main voltage transformer 100 by using the sensing voltage value (S400), the output electric current value of the current transformer 200 is calculated from the sensing voltage value, the input side electric current value of the current transformer 200 is calculated from the output side electric current value of the current transformer 200, and the output side electric current value of the main voltage transformer 100 is calculated from the input side electric current value (the input side electric current value of the main voltage transformer 100) of the current transformer 200.

Accordingly, in the electric current detection method of the low voltage DC-DC converter for an electric vehicle, according to the exemplary embodiment of the present invention, there is an effect in that the output electric current of the low voltage DC-DC converter may be detected without using a high priced electric current sensor.

described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An electric current detection apparatus of a low voltage DC-DC converter for an electric vehicle, comprising:
a low voltage DC-DC converter (LDC) configured to convert a voltage of an electric power source applied from a high voltage battery into a low voltage;
a current transformer (CT) provided at a front terminal of a main voltage transformer of the low voltage DC-DC converter and configured to convert an electric current value of an input terminal of the main voltage transformer; and
a calculation unit configured to calculate an electric current value of an output terminal of the main voltage transformer by receiving an output side electric current of the current transformer.

2. The electric current detection apparatus of claim 1, wherein the calculation unit comprises a sensing circuit configured to receive the output side electric current of the current transformer and output a voltage value, and a microcomputer configured to receive the voltage value from the sensing circuit and calculate the electric current value of the output terminal of the main voltage transformer.

3. The electric current detection apparatus of claim 2, wherein the calculation unit further comprises a smoothing circuit configured to change a voltage signal inputted from the sensing circuit to a direct current form which is convertible to a digital value by software.

4. The electric current detection apparatus of claim 2, wherein the microcomputer blocks an output of an electric power source of the main voltage transformer, when an excessive electric current flows in the input terminal of the main voltage transformer.

5. An electric current detection method of a low voltage DC-DC converter for an electric vehicle, comprising:
dropping an input side electric current of a main voltage transformer of the low voltage DC-DC converter by a current transformer;
converting an output side electric current of the current transformer into a sensing voltage value by inputting the output side electric current of the current transformer to a sensing circuit including sensing resistance; and
calculating an output side electric current value of the main voltage transformer by using the sensing voltage value.

6. The electric current detection method of claim 5, further comprising:
removing a ripple by inputting the sensing voltage value to a smoothing circuit after the converting of the output side electric current of the current transformer into the sensing voltage value.
